(19) United States
(12) Patent Application Publication
(10) Pub. No.: US 2010/0215969 A1
(43) Pub. Date: Aug. 26, 2010

(54) COATING SYSTEM FOR CEMENT COMPOSITE ARTICLES

(76) Inventors: Larry B. Brandenburger, Circle Pines, MN (US); T. Howard Killilea, North Oaks, MN (US); Daniel W. DeChaine, Anoka, MN (US); Kevin W. Evanson, maple Grove, MN (US)

Correspondence Address: IPLM GROUP, P.A., POST OFFICE BOX 18455, MINNEAPOLIS, MN, 55418, US

(21) Appl. No.: 12/671,491

(22) PCT Filed: Aug. 1, 2007
(86) PCT No.: PCT/US07/74991

§ 371 Date: May 12, 2010

(51) Int. Cl. B32B 13/12; B05D 3/06

(52) U.S. Cl. 428/447; 428/451; 427/508

(57) ABSTRACT

A coated article which includes a cement fiberboard substrate and a radiation-curable nonaqueous coating system applied to the substrate. The coating system includes one or more olefinic compounds and one or more non-olefinic resins which are soluble or dispersible in the one or more olefinic compounds. The non-olefinic resins may be chlorinated or non-chlorinated.

### CROSS-REFERENCE TO RELATED APPLICATION

This application is a U.S. national stage entry under 35. U.S.C. §371 of International Application No. PCT/US2007/074991 filed Aug. 1, 2007 and published as WO 2009/017503 A1, and claims the benefit under 35 U.S.C. §365 of International Application No. PCT/US07/002,587 filed Jan. 30, 2007 and published as WO 2007/089087 A2, which in turn claims priority from U.S. provisional patent application Ser. No. 60/764,242 filed Jan. 31, 2006, all entitled COATING COMPOSITION FOR CEMENT COMPOSITE ARTICLES and the disclosures of which are incorporated herein by reference.

### BACKGROUND

Cement composite articles are becoming more and more common for use in building materials. Many of these articles are prepared from inexpensive materials, such as cement, wood (cellulose) fibers, natural (glass) fibers and polymers. These articles usually are prepared in the form of cement fiberboard substrates such as siding panels and boards. The substrate or articles can be made using methods such as extrusion or using a Hatschek machine.

In northern climates, damage from repeated freezing and thawing of water absorbed into the cement fiberboard substrate represents a significant problem. Continued exposure to moisture, freeze-thaw cycles, UV exposure and atmospheric carbon dioxide can cause physical and chemical changes over time in articles made from cement fiberboard compositions. Coating systems or coating compositions can prevent exposure to the elements such as UV light, carbon dioxide and water, or can help reduce the damage that can occur due to exposure to these elements. Several such systems are available for protecting cement fiberboard articles. However, there is a need for coating systems and coating compositions that provide a superior seal, have the ability to cure rapidly or can provide improved results when an article coated with the composition is submitted to wet adhesion testing and multiple freeze-thaw cycles.

### SUMMARY

The present invention provides in one aspect a coated article comprising a cement fiberboard substrate and a radiation-curable nonaqueous coating system applied to the substrate, wherein the coating system comprises one or more olefinic compounds and one or more non-olefinic resins which are soluble or dispersible in the one or more olefinic compounds.

The present invention provides in another aspect a coated article comprising a cement fiberboard substrate and a radiation-curable nonaqueous coating system applied to the substrate, wherein the coating system comprises one or more olefinic compounds and one or more non-olefinic resins other than a polyvinyl chloride (PVC) resin which are soluble or dispersible in the one or more olefinic compounds.

The invention provides in yet another aspect a coated article comprising a cement fiberboard substrate and a radiation-curable nonaqueous coating system applied to the substrate, wherein the coating system comprises one or more olefinic compounds and one or more non-olefinic, non-chlorinated resins which are soluble or dispersible in the one or more olefinic compounds.

The present invention provides in a further aspect a coated article comprising a cement fiberboard substrate and a radiation-curable nonaqueous coating system applied to the substrate, wherein the coating system comprises one or more olefinic compounds and one or more non-olefinic chlorinated resins which are soluble or dispersible in the one or more olefinic compounds.

The disclosed coating systems may be applied in one or more layers, may be substantially free of volatile solvents or carriers, or may optionally include a photoinitiator system.

In another aspect, the invention provides a method for preparing a coated article, which method comprises providing a cement fiberboard substrate, coating at least a portion of the substrate with a nonaqueous coating system comprising one or more olefinic compounds and one or more non-olefinic resins dissolved or dispersed in the one or more olefinic compounds, and radiation-curing the coating.

In another aspect, the invention provides a method for preparing a coated article, which method comprises providing a cement fiberboard substrate, coating at least a portion of the substrate with a nonaqueous coating system comprising one or more olefinic compounds and one or more non-olefinic resins other than a PVC resin dissolved or dispersed in the one or more olefinic compounds, and radiation-curing the coating.

In another aspect, the invention provides a method for preparing a coated article, which method comprises providing a cement fiberboard substrate, coating at least a portion of the substrate with a nonaqueous coating system comprising one or more olefinic compounds and one or more non-olefinic, non-chlorinated resins dissolved or dispersed in the one or more olefinic compounds, and radiation-curing the coating.

In another aspect, the invention provides a method for preparing a coated article, which method comprises providing a cement fiberboard substrate, coating at least a portion of the substrate with a nonaqueous coating system comprising one or more olefinic compounds and one or more non-olefinic chlorinated resins dissolved or dispersed in the one or more olefinic compounds, and radiation-curing the coating.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying drawing and the description below. Other features, objects, and advantages of the invention will be apparent from the description and drawings, and from the claims.

### BRIEF DESCRIPTION OF THE DRAWING

FIG. 1 is a schematic cross-sectional view of a coated fiber cement article.

Like reference symbols in the various figures of the drawing indicate like elements. The elements in the drawing are not to scale.

### DETAILED DESCRIPTION

The terms “a,” “an,” “the,” “at least one,” and “one or more” are used interchangeably.

The recitation of numerical ranges by endpoints includes all numbers subsumed within that range (e.g., 1 to 5 includes 1, 1.5, 2, 2.75, 3, 3.80, 4, 5, etc.).

The term “comprises” and variations thereof does not have a limiting meaning where such term appears in the description or claims. Thus, for example, a composition comprising a wax compound means that the composition includes one or more wax compounds.

The terms “acrylate esters” and “methacrylate esters” refer to esters of acrylic acid and esters of methacrylic acid, respectively. They may be referred to as (meth)acrylates or (meth)acrylate esters.

When used with respect to a monomer, oligomer or polymer, the term “free of chloroalkylene groups” refers to a material that does not contain —CHClCH₂— radicals derived from or derivable from the polymerization of vinyl chloride. It will be understood that a coating system which contains only an incidental quantity of chloroalkylene groups, in an amount that does not measurably change the extent to which a subsequently-applied latex topcoat adheres to the coating system compared to an otherwise similar coating system containing no chloroalkylene groups, will be regarded as being free of chloroalkylene groups.

When used with respect to a coating composition, the term “nonaqueous” refers to a composition that does not contain water or that contains only a minor amount of water but not an amount sufficient to make the composition waterborne, that is, not enough water to serve by itself as a carrier for the coating system.

When used with respect to a monomer, oligomer or polymer, the term “non-olefinic compound” refers to a material that is not an olefinic compound.

The term “olefinic group” refers to a reactive ethylenic unsaturated functional group. The term “olefinic compound” refers to any monomer, oligomer or polymer containing olefinic groups, such as vinyls, (meth)acrylates, vinyl ethers, allyl ethers, vinyl esters, unsaturated oils (including mono, di and triglycerides), unsaturated fatty acids, unsaturated polyesters and the like. It will be understood that a coating system which contains only an incidental quantity of olefinic groups, in an amount insufficient to render the coating system radiation curable in the presence of a suitable photoinitiator and energy source, or in the presence of a suitable electron beam energy source, will be regarded as containing non-olefinic compound(s).

The terms “reactive sites” or “reactive groups” refer to a group that can react to form a covalent bond linking or otherwise chemically joining two or more molecules.

The present invention provides a coating system for a cement fiberboard substrate, such as a cement fiberboard siding product or other cement composite article. The coating system is a radiation-curable coating system applied to the substrate, wherein the coating system includes one or more olefinic compounds and one or more non-olefinic resins which are soluble or dispersible in the one or more olefinic compounds. The non-olefinic resins may be non-chlorinated (e.g., free of chloroalkylene groups or grafted chlorine atoms), may be a resin other than a PVC resin, or may be chlorinated (including PVC resins).

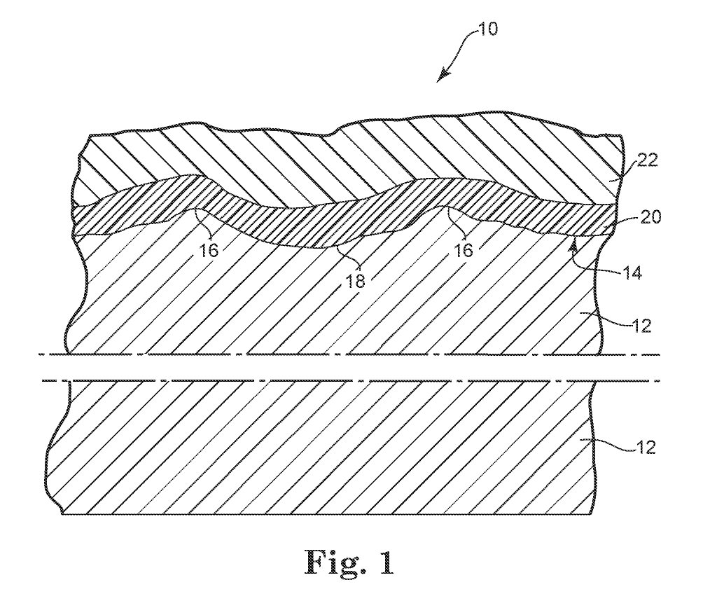

Referring to FIG. 1, a coated article 10 of the present invention is shown in schematic cross-sectional view. Article 10 includes a cement fiberboard substrate 12. Substrate 12 typically is quite heavy and may for example have a density of about 1 to about 1.6 g/cm³ or more. The first major surface 14 of substrate 12 may be embossed with small peaks or ridges 16 and valleys 18, e.g., so as to resemble roughsawn wood. Major surface 14 may have a variety of other surface configurations, and may resemble a variety of building materials other than roughsawn wood. Layer or layers 20 of the disclosed coating system lie atop and partially penetrate surface 14, and desirably are applied to article 10 at the location where article 10 is manufactured. Layers 20 help to protect substrate 12 against one or more of exposure to moisture, freeze-thaw cycles, UV exposure or atmospheric carbon dioxide. Layers 20 also may provide a firmly-adhered base layer upon which one or more firmly-adhered layers of final topcoat 22 may be formed. Final topcoat 22 desirably is both decorative and weather-resistant, and may be applied to article 10 at the location where article 10 is manufactured or after article 10 has been attached to a building or other surface.

The disclosed articles may be coated on one or more surfaces with the disclosed radiation-curable coating system. The coating system includes one or more coating compositions that may be applied in one or more layers. The coating system may be provided in a variety of embodiments. In one exemplary embodiment, the coating system includes a first coating composition that includes at least one olefinic compound, and a second coating composition that includes at least one non-olefinic resin. The two coating compositions may be applied to the substrate sequentially or concurrently and sequentially or simultaneously cured using radiation. In another exemplary embodiment the coating system includes at least one olefinic compound and at least one non-olefinic resin, and may be applied to the substrate and cured using radiation. The disclosed coating systems have particular utility for coating the bottom surface of a cement fiberboard article while it is being transported on a conveying system (e.g., on belts, rollers, air tables or the like), as described in applicants' copending International Application No. PCT/US07/61327 filed Jan. 30, 2007 and entitled METHOD FOR COATING A CEMENT FIBERBOARD ARTICLE.

The olefinic compound in the disclosed coating systems appears to function as a reactive penetrant. This may be better appreciated by observing the coating system after it is applied to the substrate but before radiation curing is performed. The olefinic compound appears to improve wetting or penetration, and may help draw other components in the coating system into pores in the substrate. The olefinic compound also appears to help the cured coating adhere to the substrate following cure. The non-olefinic resin may limit wetting, penetration or the crosslink density of the cured coating system, and may help prevent other components in the coating system from penetrating so deeply into pores in the substrate that they can not be sufficiently radiation cured. The non-olefinic resin also may increase the adhesion of subsequently-applied coatings (e.g., a latex topcoat) to the coated substrate, for example by enhancing wet-out (viz., spreading) or bite (viz., intercoat adhesion) by the subsequently-applied coating.

Preferred coating systems may also include one or more of the following additional features:
increasing the resistance of the article to water uptake (into the article);
increasing the surface integrity of the article (e.g., by acting to reinforce the fiber and cement matrix much like binder in other composite materials);
protecting against expansion of the article under freeze/thaw conditions; or
increasing the integrity of the edges of the article by binding the fiber layers together.

A variety of cement fiberboard substrates may be employed in the disclosed articles. The disclosed substrates typically include cement and a filler. Exemplary fillers include wood, fiberglass, polymers or mixtures thereof. The substrates can be made using methods such as, extrusion, the Hatschek method, or other methods known in the art. See, e.g., U.S. Patent Application No. 2005/0208285 A1 (corresponds to International Patent Application No. WO 2005/071179 A1); Australian Patent Application No. 2005100347; International Patent Application No. WO 01/68547 A1; International Patent Application No. WO 98/45222 A1; U.S. Patent Application Nos. 2006/0288909 A1 and 2006/0288909 A1; and Australian Patent Application No. 198060655 A1. Non-limiting examples of such substrates include siding products, boards and the like, for uses including fencing, roofing, flooring, wall boards, shower boards, lap siding, vertical siding, soffit panels, trim boards, shaped edge shingle replicas and stone or stucco replicas. One or both major surfaces of the substrate may be profiled or embossed to look like a grained or roughsawn wood or other building product, or scalloped or cut to resemble shingles. The uncoated substrate surface typically contains a plurality of pores with micron- or submicron-scale cross-sectional dimensions.

A variety of suitable fiber cement substrates are commercially available. For example, several preferred fiber cement siding products are available from James Hardie Building Products Inc. of Mission Viejo, Calif., including those sold as HARDIEHOME™ siding, HARDIPANEL™ vertical siding, HARDIPLANK™ lap siding, HARDIESOFFIT™ panels, HARDITRIM™ planks and HARDISHINGLE™ siding. These products are available with an extended warranty, and are said to resist moisture damage, to require only low maintenance, to not crack, rot or delaminate, to resist damage from extended exposure to humidity, rain, snow, salt air and termites, to be non-combustible, and to offer the warmth of wood and the durability of fiber cement. Other suitable fiber cement siding substrates include AQUAPANEL™ cement board products from Knauf USG Systems GmbH & Co. KG of Iserlohn, Germany, CEMPLANK™, CEMPANEL™ and CEMTRIM™ cement board products from Cemplank of Mission Viejo, Calif.; WEATHERBOARDS™ cement board products from CertainTeed Corporation of Valley Forge, Pa.; MAXITILE™, MAXISHAKE™ AND MAXISLATE™ cement board products from MaxiTile Inc. of Carson, Calif.; BRESTONE™, CINDERSTONE™, LEDGESTONE™, NEWPORT BRICK™, SIERRA PREMIUM™ and VINTAGE BRICK™ cement board products from Nichiha U.S.A., Inc. of Norcross, Ga., EVERNICE™ cement board products from Zhangjiagang Evernice Building Materials Co., Ltd. of China and E BOARD™ cement board products from Everest Industries Ltd. of India.

A variety of olefinic compounds may be used in the disclosed coating systems. The olefinic compounds are distinct from the non-olefinic resins, can dissolve the chosen non-olefinic resin, and are carbon-containing compounds having at least one site of unsaturation which can react, optionally in the presence of an initiator, to provide polymeric or crosslinked products. Non-limiting examples of olefinic compounds include monomers such as (meth)acrylates, vinyls, vinyl ethers, allyl ethers, vinyl esters, unsaturated oils (including mono-, di- and tri-glycerides), unsaturated fatty acids and the like or mixtures thereof. The olefinic compounds also include oligomers or polymers having at least one site of unsaturation which can react, optionally in the presence of an initiator, to provide polymeric or crosslinked products. Non-limiting examples of such oligomers and polymers include unsaturated alkyds and other unsaturated polyesters.

Exemplary olefinic monomers include (meth)acrylate esters of unsubstituted or substituted C₁-C₁₅ alcohols such as tripropylene glycol, isobornyl alcohol, isodecyl alcohol, phenoxyethyl alcohol, trishydroxyethyl isocyanurate, trimethylolpropane ethoxylate (TMPTA), ditrimethylolpropane ethoxylate (diTMPTA), hexanediol, ethoxylated neopentyl glycol, propoxylated neopentyl glycol, ethoxylated phenol, polyethylene glycol, bisphenol A ethoxylate, trimethylolpropane, propoxylated glycerol, pentaerythritol, di-pentaerythritol, tetrahydrofurfuryl alcohol, β-carboxyethyl alcohol, or combination thereof. For example, the olefinic monomer may be isobornyl(meth)acrylate, isodecyl(meth)acrylate, phenoxyethyl(meth)acrylate, trimethylolpropane tri(meth)acrylate, alkoxylated cyclohexane dimethanol di(meth)acrylate, trimethylolpropane ethoxylate tri(meth)acrylate, dipropylene glycol di(meth)acrylate, tripropylene glycol di(meth)acrylate, hexanediol di(meth)acrylate, tetrahydrofurfuryl(meth)acrylate, pentaerythritol tri(meth)acrylate, pentaerythritol tetra(meth)acrylate, di-pentaerythritol penta(meth)acrylate, di-(trimethylolpropane tetra(meth)acrylate), propoxylated glycerol tri(meth)acrylate, beta-carboxyethyl(meth)acrylate, bisphenol A ethoxylate di(meth)acrylate, ethoxylated neopentyl glycol di(meth)acrylate, propoxylated neopentyl glycol di(meth)acrylate or combination thereof. Preferred olefinic monomers include isobornyl(meth)acrylate, tripropylene glycol di(meth)acrylate, trimethylolpropane tri(meth)acrylate, bisphenol A ethoxylate di(meth)acrylate, trimethylolpropane ethoxylate tri(meth)acrylate, dipropylene glycol di(meth)acrylate, di-pentaerythritol penta(meth)acrylate, di-(trimethylolpropane tetra(meth)acrylate), propoxylated glycerol tri(meth)acrylate or combination thereof. The olefinic monomer may contain a (C₁-C₁₅) alcohol radical such as hydroxymethyl, 1-hydroxyethyl, 2-hydroxyethyl, 1-hydroxypropyl, 2-hydroxypropyl, 3-hydroxypropyl, 1-hydroxybutyl, 4-hydroxybutyl, 1-hydroxypentyl, 5-hydroxypentyl, 1-hydroxyhexyl, 6-hydroxyhexyl, 1,6-dihydroxyhexyl, 1,4-dihydroxybutyl, and the like.

Exemplary allyl ether monomers contain one or more allyl ether groups which typically are bonded to a core structural group which can be based on a wide variety of polyhydric alcohols. Non-limiting examples of suitable polyhydric alcohols include neopentyl glycol, trimethylolpropane, ethylene glycol, propylene glycol, butylene glycol, diethylene glycol, trimethylene glycol, triethylene glycol, trimethylolethane, pentaerythritol, glycerol, diglycerol, 1,4-butanediol, 1,6-hexanediol, 1,4-cyclohexanedimethanol, and any of the other polyols mentioned above in connection with the (meth)acrylate esters. Other exemplary allyl ether monomers include hydroxyethyl allyl ether, hydroxypropyl allyl ether, trimethylolpropane monoallyl ether, trimethylolpropane diallyl ether, trimethylolethane monoallyl ether, trimethylolethane diallyl ether, glycerol monoallyl ether, glycerol diallyl ether, pentaerythritol monoallyl ether, pentaerythritol diallyl ether, pentaerythritol triallyl ether, 1,2,6-hexanetriol monoallyl ether, 1,2,6-hexanetriol diallyl ether, and the like. Preferred allyl ethers include poly propoxylated and ethoxylated forms of allyl ethers.

Exemplary vinyl ether monomers contain one or more vinyl ether groups and include 4-hydroxybutyl vinyl ether, 1,4-cyclohexanedimethanol monovinyl ether, 1,4-cyclohexanedimethanol divinyl ether, ethylene glycol monovinyl ether, ethylene glycol divinyl ether, diethylene glycol monovinyl ether, diethylene glycol divinyl ether, triethylene glycol divinyl ether, and the like. Preferred vinyl ether monomers include propoxylated or ethoxylated forms of vinyl ether monomers.

Exemplary unsaturated alkyds and other unsaturated polyesters are described in U.S. Pat. Nos. 4,742,121, 5,567,767, 5,571,863, 5,688,867, 5,777,053, 5,874,503 and 6,063,864 and in PCT Published Application Nos. WO 94/07674 A1, WO 00/23495 A1 and WO 03/101918A2. They may be prepared from the condensation of one or more carboxylic acids (such as mono, di- or poly-functional unsaturated or saturated carboxylic acids) or their derivatives (such as acid anhydrides, C₁₋₈ alkyl esters, etc.) with one or more alcohols (including mono-functional, di-functional and poly-functional alcohols). The carboxylic acid or derivative may for example be a mixture of an unsaturated carboxylic acid or derivative and a saturated carboxylic acid or derivative. The unsaturated carboxylic acids or their derivatives may for example have about 3 to about 12, about 3 to about 8, or about 4 to about 6 carbon atoms. Representative unsaturated carboxylic acids and their derivatives include maleic acid, fumaric acid, chloromaleic acid, itaconic acid, citraconic acid, methylene glutaric acid, mesaconic acid, acrylic acid, methacrylic acid, and esters or anhydrides thereof. Representative unsaturated carboxylic acids and their derivatives include maleic, fumaric acids, fumaric esters and anhydrides thereof. An unsaturated carboxylic acid or its derivative may for example be present in an amount from about 2 to about 90 mole percent, about 5 to about 50 mole percent, or about 10 to about 25 mole percent of the acids or acid derivatives used to make the unsaturated polyester. The saturated carboxylic acids and their derivatives may for example have from about 8 to about 18, about 8 to about 15, or about 8 to about 12 carbon atoms. Representative saturated carboxylic acids and their derivatives may be aromatic, aliphatic or a combination thereof, and include succinic acid, glutaric acid, d-methylglutaric acid, adipic acid, sebacic acid, pimelic acid, phthalic anhydride, o-phthalic acid, isophthalic acid, terephthalic acid, dihydrophthalic acid, tetrahydrophthalic acid, hexahydrophthalic acid or anhydride, tetrachlorophthalic acid, chlorendic acid or anhydride, dodecanedicarboxylic acids, nadic anhydride, cis-5-norbornene-2,3-dicarboxylic acid or anhydride, dimethyl-2,6-naphthenic dicarboxylate, dimethyl-2,6-naphthenic dicarboxylic acid, naphthenic dicarboxylic acid or anhydride and 1,4-cyclohexane dicarboxylic acid. Other representative carboxylic acids include ethylhexanoic acid, propionic acid, trimellitic acid, benzoic acid, 1,2,4-benzenetricarboxylic acid, 1,2,4,5-benzenetetracarboxylic acid and anhydrides thereof. Representative aromatic saturated carboxylic acids include o-phthalic acid, isophthalic acid and their derivatives. The aromatic carboxylic acids or their derivatives may for example be present in an amount from about 10 to about 98 mole percent, about 20 to about 90 mole percent, or about 40 to about 85 mole percent of the acids or acid derivatives used to make the unsaturated polyester. Representative aliphatic saturated carboxylic acids include 1,4-cyclohexane dicarboxylic acid, hexahydrophthalic acid, adipic acid and their derivatives. The saturated carboxylic acids or their derivatives may for example be present in an amount from about 0 to about 90 mole percent, about 0 to about 50 mole percent, or about 0 to about 25 mole percent of the acids or acid derivatives used to make the unsaturated polyester.

Suitable alcohols used to make the unsaturated polyester include compounds such as aliphatic, cycloaliphatic or araliphatic alcohols having 1 to 6, preferably 1 to 4, hydroxy groups attached to nonaromatic or aromatic carbon atoms. Examples of suitable polyols include ethylene glycol, 1,2-propanediol, 1,3-propanediol, 1,2-butanediol, 1,3-butanediol, 1,4-butanediol, 2-ethyl-1,3-propanediol, 2-methyl-1,3-propanediol, 2-butyl-2-ethylpropanediol, 2-ethyl-1,3-hexanediol, 1,3 neopentyl glycol, 2,2-dimethyl-1,3-pentanediol, 1,6 hexanediol, 1,2- and 1,4-cyclohexanediol, bisphenol A, 1,2- and 1,4-bis(hydroxymethyl)cyclohexane, bis(4-hydroxycyclohexyl)methane, adipic acid bis-(ethylene glycol ester), ether alcohols such as diethylene glycol and triethylene glycol, dipropylene glycol, perhydrogenated bisphenols, 1,2,4-butanetriol, 1,2,6-hexanetriol, trimethylolethane, trimethylolpropane, trimethylolhexane, glycerol, pentaerythritol, dipentaerythritol, mannitol and sorbitol, and also chain-terminating monoalcohols having 1 to 8 carbon atoms such as propanol, butanol, cyclohexanol, benzyl alcohol, hydroxypivalic acid and mixtures thereof. Preferred polyols include glycerol, trimethylolpropane, methyl propane diol, neopentyl glycol, diethylene glycol and pentaerythritol. Alcohols may for example be present in an amount from about 10 to about 90 mole percent, about 20 to about 60 mole percent, or about 35 to about 55 mole percent of the alcohols and acids or acid derivatives used to make the unsaturated polyester.

A subset of the previously mentioned olefinic compounds (e.g., hexanediol di(meth)acrylate, trimethylolpropane tri(meth)acrylate and di-(trimethylolpropane tetra(meth)acrylate)) has multiple (e.g., two or more) reactive groups. These monomers or oligomers can function as crosslinking agents.

The disclosed coating systems preferably contain about 20 to about 95% by weight of olefinic compounds based on the total weight of the non-volatile components in the coating system, preferably about 30 to about 90% by weight, more preferably about 40 to about 85% by weight, and most preferably about 50 to about 80% by weight. In one exemplary embodiment, the olefinic compounds comprise a mixture of an acrylate or methacrylate monomer and an unsaturated polyester, with the acrylate or methacrylate monomer representing a majority of the mixture.

A variety of non-olefinic resins may be used in the disclosed coating systems and method. Representative non-olefinic resins include resins other than PVC, non-chlorinated resins and chlorinated resins including PVC. Preferred non-olefinic resins are thermoplastics, as they tend to dissolve more readily in the olefinic compound(s). The non-olefinic resin desirably also is obtained in finely-divided (e.g., powdered, pelletized or flaked) or dispersed form so as to facilitate its dissolution in the olefinic compound(s). Exemplary resins other than PVC and exemplary non-chlorinated resins include acrylic polymers, cellulose esters and other cellulosic polymers, fluoropolymers, hydrocarbon resins, saturated alkyds and other saturated polyesters, silicone polymers, and non-chlorinated vinyl polymers such as polyethylene, polypropylene, polypropylene and polystyrene. It should be noted that some of the above-mentioned non-olefinic resins (e.g., fluoropolymer resins and silicone resins) may reduce significantly the surface energy of the cured coating composition. This may discourage adhesion of some subsequently-applied topcoats (e.g., latex topcoats). In such instances, a lower surface energy topcoat may be selected or the coating composition may be used as a combination sealer/topcoat without further topcoating, or the amount of non-olefinic resin may be reduced in comparison to non-olefinic resins that provide higher surface energy cured coatings.

A wide variety of non-chlorinated non-olefinic resins may be employed in the disclosed coating systems. Exemplary commercially available acrylic polymers include the PARALOID™ A series, AE series, AT series, AU series, B series, BPM series, BTA Series, EXL series, HIA series, K series and KM series, all from Rohm and Haas Company. Acrylic polymers tend to dissolve readily in acrylate and methacrylate monomers and represent a preferred subclass of non-olefinic monomers. Exemplary commercially available cellulosic polymers include the EASTMAN CA series of cellulose acetates and triacetates, CAB and CMCAB series of cellulose acetate butyrates and CAP series of cellulose acetate propionates from Eastman Chemical Company and the TENITE™ series of acetates and butyrates from Eastman Chemical Company. Exemplary commercially available fluoropolymers include the KYNAR™ series of polyvinylidene fluoride resins from Arkema and the HYLAR™ series of polyvinylidene fluoride resins from Solvay Solexis, Inc. Exemplary commercially available hydrocarbon resins include ARKON™ resins from Arakawa Chemical; SYLVACOATT™. SYLVAPRINT™, SYLVAGUM™, SYLVARES™ and ZONATAC™ resins from Arizona Chemical Co.; the PICCO™ and PLASTOLYN™ series of aromatic resins, the PICCOTAC™ series of aliphatic/aromatic resins, the EASTOTAC™, REGALITE™, REGALREZ™ and “DCPD” (dicyclopentadiene) series of hydrogenated resins and the ENDEX™, KRISTALEX™, PICCOLASTIC™ and PICCOTEX™ series of styrene or modified styrene “pure monomer” resins, all from Eastman Chemical Company; ESCOREZ™ hydrocarbon resins from ExxonMobil Chemical; the NORSOLENE™ A series, S series and W Series resins and WINGTACKT™ resins from Sartomer Chemical; and CLEARON™ resins from Yasuhara Chemical Co. Exemplary saturated polyester resins include DESMOPHEN™ saturated polyesters from Bayer Chemical Co., URALAC™ saturated polyesters from DSM and AROPLAZ™ resins from Reichhold Inc. Exemplary silicone polymers include DOW CORNING™ Z-6018 hydroxy-functional silicone intermediate. Exemplary non-chlorinated, saturated vinyl polymers include the various low or high density, linear low density or ultra low density polyethylenes available from Dow Chemical Co. such as the ATTAINT™, DOW™, DOWLEX™, ELITE™, FLEXOMER™ and TUFFLINT™ series resins, and the various EXXONMOBIL™ and EXCEED™ polyethylenes available from ExxonMobil Chemical. Exemplary polypropylene resins include those available from Dow Chemical Co. and ExxonMobil Chemical. Exemplary polystyrene resins include high impact polystyrene from Total Petrochemicals.

A variety of chlorinated resins may also or instead be used in the disclosed coating systems. Exemplary chlorinated resins include PVC dispersion resins, chlorinated PVC (CPVC) resins and chlorinated polyolefins. PVC dispersion resins typically contain resin particles (or a mixture of particles of various resins or missed resins) in a liquid plasticizer. The PVC dispersion resin may for example include a PVC homopolymer, copolymer or a combination thereof, and various additives. PVC dispersion resins can be made by emulsion polymerization, micro-suspension polymerization or by a process borrowing from both techniques. PVC dispersion resins typically have very fine particles (e.g., an average particle diameter of about 0.1 μm to about 1.5 μm. Typically, the PVC dispersion resin particles show little or no porosity and have very high surface area. When sufficient plasticizer is added to a dispersion resin (e.g., about 40 phr or higher) a liquid suspension which may be called a plastisol or organosol is obtained. Copolymers of vinyl chloride and other monomers such as acetates and acrylates can be used to produce dispersion resins. PVC dispersion resins are typically produced by suspension polymerization and have an average particle size range of about 25 μm to 75 μm. The PVC dispersion resins are preferably free of ethylenic unsaturation. Exemplary commercially available PVC dispersion resins include GEON™ resins (e.g., GEON 137, 171, and 172) from PolyOne Corporation, Avon Lake, Ohio and NORVINYL™ resins (e.g., NORVINYL 56261, 56571, 57060 and 58060) from Hydro Polymers, Oslo, Norway. Exemplary CPVC resins are available from Lubrizol, Inc. Exemplary chlorinated polyolefins are available from Eastman Chemical Company.

Mixtures of non-olefinic resins may be employed in the disclosed coating systems, including mixtures of non-olefinic, non-chlorinated resins; mixtures of non-olefinic, non-chlorinated resins with non-olefinic, chlorinated resins; and mixtures of non-olefinic, chlorinated resins.

The disclosed coating systems preferably contain about 5 to about 80% by weight non-olefinic resin based on the total weight of the non-volatile components in the coating system, more preferably about 10 to about 70% by weight, yet more preferably about 20% to about 50% by weight and most preferably about 20% to about 35% by weight. Lower amounts may be preferred, e.g., about 0.5% to about 30%, when the non-olefinic resin is a fluoropolymer or silicone.

The olefinic compounds are curable by radiation, e.g., visible light, ultra violet light, electron beam, microwave, gamma radiation, infrared radiation and the like. An initiator system is not required for electron beam curing but for other radiation sources typically will be chosen based on the particular type of curing energy (e.g., UV, visible light or other energy) and cationic, free-radical, cationic or other curing mechanism) employed. Thus in one preferred embodiment, the coating system is electron beam curable and does not require an initiator. In another preferred embodiment, the coating system is UV curable and free-radically polymerizable, and includes a UV photoinitiator system which generates free radicals in response to UV light and thereby cures the coating.

Non-limiting examples of initiators include peroxide compounds, azo compounds, cationic-generating initiators, cleavage-type initiators, hydrogen abstraction-type initiators, and the like. Exemplary peroxide compounds include t-butyl perbenzoate, t-amyl perbenzoate, cumene hydroperoxide, t-amyl peroctoate, methyl ethyl ketone peroxide, benzoyl peroxide, cyclohexanone peroxide, 2,4-pentanedione peroxide, di-t-butyl peroxide, t-butyl hydroperoxide and di-(2-ethylhexyl)-peroxydicarbonate. Preferably, the curing agent is t-butyl perbenzoate, methyl ethyl ketone peroxide, or cumene hydroperoxide. Methyl ethyl ketone peroxide conveniently is employed as a solution in dimethyl phthalate, e.g., LUPERSOL™ DDM-9 from Ato-Chem.

Exemplary azo compounds include 2,2-azo bis-(2,4-dimethylpentane-nitrile), 2,2-azo bis-(2-methylbutanenitrile) and 2,2-azo bis-(2-methylpropanenitrile).

Exemplary cationic-generating photoinitiators include super acid-generating photoinitiators such as triaryliodonium salts, triarylsulfonium salts and the like. A preferred triarylsulfonium salt is triphenyl sulfonium hexafluorophosphate.

Exemplary cleavage-type photoinitiators include α,α-diethoxyacetophenone (DEAP); dimethoxyphenylacetophenone (IRGACURE™ 651); hydroxycyclo-hexylphenylketone (IRGACURE™ 184); 2-hydroxy-2-methyl-1-phenylpropan-1-one (DAROCUR™ 1173); a 25:75 blend of bis-(2,6-dimethoxybenzoyl)-2,4,4-trimethylpentyl phosphine oxide and 2-hydroxy-2-methyl-1-phenylpropan-1-one (IRGACURE™ 1700), a 50:50 blend of hydroxycyclo-hexylphenylketone and benzophenone (IRGACURE™ 500), 50:50 blend of 2,4,6-trimethylbenzoyl-diphenyl-phosphineoxide and 2-hydroxy-2-methyl-1-phenyl-propan-1-one (DAROCUR™ 4265), bis acryl phosphine (IRGACURE™ 819) and phosphine oxide (IRGACURE™ 2100), all available from Ciba Corporation, Ardsley, N.Y. Other cleavage-type initiators include 2,4,6-trimethylbenzoyl-diphenylphosphine oxide (LUCIRIN™ TPO) from BASF Corporation and a 70:30 blend of oligo 2-hydroxy-2-methyl-[4-(1-methylvinyl)phenyl]propan-1-one and 2-hydroxy-2-methyl-1-phenylpropan-1-one (KIP™ 100) available from Sartomer (Exton, Pa.). Preferred cleavage-type photoinitiators are hydroxycyclo-hexylphenylketone, 2-hydroxy-2-methyl-1-phenylpropan-1-one, benzophenone, 2,4,6-trimethylbenzoyl-diphenylphosphine oxide bis acryl phosphine and a 70:30 blend of 2-hydroxy-2-methyl-[4-(1-methylvinyl)phenyl]propan-1-one and 2-hydroxy-2-methyl-1-phenylpropan-1-one.

Non-limiting examples of hydrogen abstraction-type photoinitiators include benzophenone, substituted benzophenones (e.g., ESCACURE™ TZT of Fratelli-Lamberti) and other diaryl ketones such as xanthones, thioxanthones, Michler's ketone, benzil, quinones and substituted derivatives of all of the above. Camphorquinone is an example of a compound that may be used when one desires to cure a coating system with visible light.

For coating compositions or systems having an olefinic compound including a mixture of two or more of a (meth)acrylate, an allyl ether and a vinyl ether functional group, a combination of curing procedures can be used. For example, a coating composition having a (meth)acrylate and a vinyl ether functional group typically may include an α-cleavage-type or hydrogen abstraction type photoinitiator for polymerization of the (meth)acrylate groups and a cationic-generating photoinitiator for polymerization of the vinyl ether groups.

If desired, the coating composition or system may also include a co-initiator or photoinitiator synergist. Non-limiting examples of co-initiators include (1) tertiary aliphatic amines such as methyl diethanol amine and triethanol amine; (2) aromatic amines such as amylparadimethylaminobenzoate, 2-n-butoxyethyl-4-(dimethylamino) benzoate, 2-(dimethylamino)ethylbenzoate, ethyl-4-(dimethylamino)benzoate and 2-ethylhexyl-4-(dimethylamino)benzoate; (3) (meth)acrylated amines such as EBECRYL™ 7100 and UVECRYL™ P104 and P115, all from UCB RadCure Specialties; and (4) amino-functional acrylate or methacrylate resin or oligomer blends such as EBECRYL™ 3600 or EBECRYL™ 3703, both from UCB RadCure Specialties. Combinations of the above four categories of co-initiators may also be used.

In the case of visible or UV radiation curing systems, the preferred amount of photoinitiator present in the disclosed coating systems can be from about 0.2 to about 15 wt. % of the non-volatile components. More preferably the photoinitiator can be from about 0.5 to about 10 wt. %, and most preferably the photoinitiator can be from about 0.75 to about 5 wt. % of the non-volatile components.

Other methods for curing the coating systems can be used in combination with methods described herein Such other curing methods include heat cure, chemical cure, anaerobic cure, moisture cure, oxidative cure, and the like. Such methods may require inclusion of a corresponding curing initiator or curing agent in the composition. For example, heat cure can be induced by peroxides, metal curing packages can induce an oxidative cure, or multifunctional amines (for example isophorone diamine) can effect a chemical crosslinking cure through Michael addition of amine groups onto acrylate reactive unsaturated groups. If these additional initiators are present in the coating system they typically make up about 0.1-12% by weight of the curable coating system. Means for effecting cures by such methods are known to those of skill in the art or can be determined using standard methods.

The disclosed coating systems are as noted nonaqueous and preferably contain less than 10%, less than 5% or less than 2% water based on the total coating system weight. This makes it easier to cure the coating composition and can obviate the need for a drying oven. The coating systems may if desired contain minor amounts of solvents or solubilizing agents to assist in dissolving or dispersing the one or more non-olefinic resins in the one or more olefinic compounds, or to make a formulation in which the non-olefinic resins would form a dispersion become or behave like a formulation in which the non-olefinic resins form a solution. If used, such solvents or solubilizing agents preferably are low volatile organic content (VOC) materials or non-VOC materials. The coating systems may also contain an optional coalescent and many coalescents are known in the art. The optional coalescent is preferably a low VOC coalescent such as is described in U.S. Pat. No. 6,762,230. Preferably however the coating systems are 100% solids formulations.

Other optional components for use in the coating systems herein are described in Koleske et al., Paint and Coatings Industry, April, 2003, pages 12-86. Typical performance enhancing additives that may be employed include surface active agents, pigments, colorants, dyes, surfactants, dispersants, defoamers, thickeners, heat stabilizers, leveling agents, coalescents, biocides, mildewcides, anti-cratering agents, curing indicators, plasticizers, fillers, sedimentation inhibitors, ultraviolet light absorbers, optical brighteners, and the like to modify properties. The amounts and types of such additives will be known to those of skill in the art or can be determined using standard methods.

The disclosed coating systems or coating compositions preferably have improved, viz., lower, VOC. The coating systems or coating compositions desirably have a VOC of less than about 5%, based on the total weight of the coating system, preferably a VOC of less than about 2%, more preferably a VOC of less than about 0.5%.

Dry Adhesion may be evaluated by applying a 7.62 cm (3 inch) strip of SCOTCH™ flatback masking tape 250 from 3M Company. The tape is firmly pressed onto to the board surface with the long axis of the tape in the direction of any embossing patterns that may be present. The tape is firmly pressed onto the board by applying a minimum of 20.67 kPa (5 psi) to the full length of the tape for 10 seconds. The tape is removed rapidly (in no more than 1 second) by pulling it up at a 90 degree angle to the board. The amount of coating transferred (if any) is evaluated as a percent of the contacted coating area and the nature of the coating failure is noted. For example, failure may occur between interfacial coating layers, between the coating and the surface of the board, or within the board itself. Preferred coating systems or coating compositions have less than about 15% coating removal, more preferably less than about 10% coating removal. In addition, the failure preferably is within the board as indicated by a significant amount of fiber from the board adhering to the removed coating.

Wet adhesion testing and “freeze-thaw” cycles have been shown, under laboratory conditions, to simulate long-term outdoor exposure encountered in northern climates. A Wet Adhesion test may be performed to evaluate a coated cement fiberboard substrate that has been saturated with water. According to this test procedure, coated substrates (e.g., fiber cement boards) are soaked in room temperature water for 24 hours. After soaking, the boards are removed from the water and kept at room temperature for 24 hours. A six-inch (15.24 cm) length of SCOTCH 250 tape is applied to the surface of the board as in the Dry Adhesion test procedure. The tape is then removed by quickly pulling it off at a 90-degree angle to the board as in the Dry Adhesion test procedure, and evaluated to determine the percent of coating removed and the nature of the coating failure. Preferred coating systems or coating compositions have less than 25% coating removal, more preferably less than 15% coating removal. In addition, the failure preferably is within the board as indicated by a significant amount of fiber from the board adhering to the removed coating.

Preferred coated articles can withstand at least 30 freeze-thaw cycles, when tested according to ASTM D6944-03, Test Method A. As written, this ASTM test method recites a 30-cycle sequence. However, rather than simply grade a specimen as a “pass” at the end of 30 cycles, the test desirably is lengthened to include additional cycles. More preferably, the coated articles can withstand at least 75 freeze-thaw cycles, most preferably at least 125 freeze-thaw cycles and optimally at least 175 freeze-thaw cycles.

The disclosed method includes application of coating systems which may be applied as a single layer or as multiple applications of at least one coating composition. The specific application and order of application of the selected coating compositions can be readily determined by a person skilled in the art of preparing or applying such compositions. Exemplary descriptions of these coating systems are provided below.

Specific application routes for preparing the coated articles include:
Apply a coating system, and subject the coating system to radiation cure (e.g., electron-beam or UV cure); and
Apply a coating composition, apply one or more additional coating composition(s), and subject the resulting coating system to radiation cure (e.g., electron-beam or UV cure).

Coating compositions applied using multiple coating layers may allow mixing of the coating layers at an interface. A primer (e.g., a latex-containing primer) or topcoat (e.g., a latex-containing topcoat) or both a primer and topcoat may be applied directly to the coating system. If desired this may be done at the site where the cement fiberboard substrate is manufactured.

In any of the above application routes when there is a carrier (e.g., solvent) present in one of more of the compositions, the coated article may be subjected to quick drying to remove at least a portion of any carrier which may be present. The coating composition(s) are preferably applied at about 75 to 100% solids by weight and preferably at about 85 to 100% solids. The coating systems may be applied by any number of application techniques including but not limited to brushing (e.g., using a brush coater), direct roll coating, reverse roll coating, flood coating, dip coating, vacuum coating, curtain coating and spraying, at ambient or elevated temperatures. The various techniques each offer a unique set of advantages and disadvantages depending upon the substrate profile, morphology and tolerable application efficiencies. The coating system preferably has a viscosity at the chosen application temperature of about 50 to about 50,000 cP, more preferably about 200 to about 20,000 cP, yet more preferably about 500 to about 5,000 cP, and most preferably about 750 to about 4,000 cP, as measured using a BROOKFIELD™ viscometer with a No. 31 spindle operated at 5 rpm. Lower viscosities facilitate uniform film control. The disclosed coating systems can for example advantageously be applied to a cement fiberboard substrate by roll coating or spraying. The applied film thickness may be controlled by varying the application rate and temperature. A dry film thickness (DFT) of the coating system on the cement fiberboard substrate may for example be in the range of, but not limited to, about 0.2 to about 4 mil (about 0.005 to about 0.1 mm), more preferably about 0.3 to about 3 mil (about 0.008 to about 0.08 mm).

It is preferred that the coated articles are coated on at least one major surface with the coating system. More preferably, the coated articles are coated on a major surface and up to four minor surfaces including any edges. Most preferably, the coated articles are coated on all (e.g., both) major surfaces, and up to four minor surfaces including any edges.

The coating systems and compositions described herein may be used in place of or in addition to coatings that have previously been categorized as “sealers,” “primers” or “topcoats.” However, the systems and compositions may not fit neatly into any category per se and such terms should not be limiting.

It is also noted that the disclosed coating systems and coating compositions can be used with other coating compositions such as those disclosed in the following applications: U.S. application Ser. Nos. 11/669,131 and 11/669,134, both filed Jan. 30, 2007, and International Application Nos. PCT/US07/02347, PCT/US07/02802, PCT/US07/61326 and PCT/US07/61327, each filed Jan. 30, 2007.

### EXAMPLES

Exemplary coating systems that can be used in the coating systems are listed below. This is not intended to be an exhaustive list of examples of coating systems. The examples include the following compositions:

Composition A—One or more olefinic compounds (e.g., monomers, oligomers, or polymers) and one or more chlorinated resins. An example of such a coating system may be made by mixing (i) olefinic monomers or oligomers, (e.g., trimethylolpropane triacrylate (TMPTA) (available from Sartomer) and (ii) a PVC dispersion (e.g., GEON 137, 171 or 172 from PolyOne Corporation or NORVINYL 56261, 56571, 57060 or 58060 from Hydro Polymers).

Composition B—One or more olefinic compounds (e.g., monomers, oligomers, or polymers), one or more chlorinated resins and an initiator. An example of such a coating system may be made by mixing (i) olefinic monomers or oligomers, (e.g., trimethylolpropane tri-acrylate (TMPTA); (ii) a PVC dispersion (e.g., GEON 137, 171 or 172 from PolyOne Corporation or NORVINYL 56261, 56571, 57060 or 58060 from Hydro Polymers); and (iii) an initiator, (e.g., DAROCURE 1173 (D-1173).

Composition C—A further example of a coating system suitable for use in the invention may be made by combining in a mixing vessel the materials shown below in Table 1 and stirring until homogenous:

TABLE 1

| Ingredient (Supplier) | Parts |
|---|---|
| Tripropyleneglycol diacrylate (Sartomer) | 41.9 |
| NORSOLENE S85 hydrocarbon resin | 37.5 |
| (Sartomer) | |
| Unsaturated polyester made from a 9/26/24/41 | 20.6 |
| mixture of maleic anhydride/isophthalic acid/ | |
| phthalic anhydride/2-methyl-1,3-propanediol | |

Composition C was applied using a roll coater at about 25-30 microns thickness to a fiber cement plank and cured using an electron beam apparatus. The cured coating was topcoated with an approximately 45 micrometer dry film thickness layer of a multistage latex polymer topcoat like that shown in United States Patent Application Publication No. US 2007/0110981 A1, dried and then evaluated for Dry Adhesion and Wet Adhesion as described above. The coating system had no Dry Adhesion loss, and less than 10% Wet Adhesion loss. The resulting coating system should exhibit excellent resistance to coating degradation when subjected to repeated freeze/thaw cycles.

Exemplary embodiments of the disclosed invention also include:
1. A coated article, comprising:
   a cement fiberboard substrate; and
   a radiation-curable nonaqueous coating system applied to the substrate,
wherein the coating system comprises:
   (a) one or more olefinic compounds; and
   (b) one or more non-olefinic resins, or one or more non-olefinic resins other than a polyvinyl chloride (PVC) resin, or one or more non-olefinic, non-chlorinated resins, or one or more non-olefinic chlorinated resins, which non-olefinic resins are soluble or dispersible in the one or more olefinic compounds.
2. The article of embodiment 1, wherein the non-olefinic resin is dissolved or dispersed in the olefinic compound.
3. The article of any preceding embodiment, wherein the coating system further comprises an initiator system.
4. The article of embodiment 3, wherein the coating system comprises a UV photoinitiator.
5. The article of any preceding embodiment, wherein the coating system is substantially free of volatile solvents or carriers.
6. The article of any preceding embodiment, wherein the olefinic compound comprises a monomer.
7. The article of any preceding embodiment, wherein the olefinic compound comprises a (meth)acrylate, vinyl, vinyl ether, allyl ether, vinyl ester, unsaturated oil, unsaturated fatty acid, unsaturated polyester, unsaturated alkyd or combination thereof
8. The article of any preceding embodiment, wherein the olefinic compound comprises isobornyl(meth)acrylate, isodecyl(meth)acrylate, phenoxyethyl(meth)acrylate, trimethylolpropane tri(meth)acrylate, alkoxylated cyclohexane dimethanol di(meth)acrylate, trimethylolpropane ethoxylate tri(meth)acrylate, dipropylene glycol di(meth)acrylate, tripropylene glycol di(meth)acrylate, hexanediol di(meth)acrylate, tetrahydrofurfuryl(meth)acrylate, pentaerythritol tri(meth)acrylate, pentaerythritol tetra(meth)acrylate, di-pentaerythritol penta(meth)acrylate, di-(trimethylolpropane tetra(meth)acrylate), propoxylated glycerol tri(meth)acrylate, beta-carboxyethyl(meth)acrylate, bisphenol A ethoxylate di(meth)acrylate, ethoxylated neopentyl glycol di(meth)acrylate, propoxylated neopentyl glycol di(meth)acrylate, or combination thereof
9. The article of any preceding embodiment, wherein the olefinic compound comprises isobornyl(meth)acrylate, tripropylene glycol di(meth)acrylate, trimethylolpropane tri(meth)acrylate, bisphenol A ethoxylate di(meth)acrylate, trimethylolpropane ethoxylate tri(meth)acrylate, dipropylene glycol di(meth)acrylate, di-pentaerythritol penta(meth)acrylate, di-(trimethylolpropane tetra(meth)acrylate), propoxylated glycerol tri(meth)acrylate or combination thereof
10. The article of any preceding embodiment, wherein the olefinic compound comprises a mixture of an acrylate or methacrylate monomer and an unsaturated polyester, with the acrylate or methacrylate monomer representing a majority of the mixture.
11. The article of any of embodiments 1 to 5, wherein the olefinic compound comprises an oligomer.
12. The article of any of embodiments 1 to 5, wherein the olefinic compound comprises an unsaturated polyester or unsaturated alkyd.
13. The article of any preceding embodiment, wherein the non-olefinic resin comprises a finely-divided thermoplastic.
14. The article of any preceding embodiment, wherein the non-olefinic resin comprises a non-chlorinated resin.
15. The article of any preceding embodiment, wherein the non-olefinic resin comprises an acrylic polymer, cellulosic polymer, fluoropolymer, hydrocarbon resin, saturated polyester, saturated alkyd, silicone polymer, or a non-chlorinated, saturated vinyl polymer.
16. The article of any preceding embodiment, wherein the non-olefinic resin comprises polystyrene.
17. The article of any of embodiments 1 to 13, wherein the non-olefinic resin comprises a chlorinated resin.
18. The article of embodiment 17, wherein the non-olefinic resin comprises chlorinated polyvinyl chloride or a chlorinated polyolefin.
19. The article of any preceding embodiment, wherein a latex-containing primer or latex-containing topcoat is applied over the coating system.
20. The article of any preceding embodiment, wherein the cement fiberboard substrate is in the form of a siding product.
21. The article of any preceding embodiment, wherein the coated article when radiation cured can withstand at least 30 freeze-thaw cycles.
22. The article of embodiment 21, wherein the coated article can withstand at least 75 freeze-thaw cycles.
23. The article of embodiment 21, wherein the coated article can withstand at least 175 freeze-thaw cycles.
24. The article of any preceding embodiment, wherein the coating system has a VOC of less than about 5% based on the total weight of the coating system.
25. The article of embodiment 24, wherein the coating system has a VOC of less than about 2% based on the total weight of the coating system.
26. A method for preparing a coated article, which method comprises providing a cement fiberboard substrate, coating at least a portion of the substrate with a nonaqueous coating system comprising (a) one or more olefinic compounds and (b) one or more non-olefinic resins, or one or more non-olefinic resins other than a polyvinyl chloride (PVC) resin, or one or more non-olefinic, non-chlorinated resins, or one or more non-olefinic chlorinated resins, which non-olefinic resins are dissolved or dispersed in the one or more olefinic compounds, and radiation-curing the coating.
27. The method of embodiment 26, wherein the coating system further comprises an initiator system.
28. The method of embodiment 27, wherein the coating system comprises a UV photoinitiator.
29. The method of any of embodiments 26 to 28, wherein the coating system is substantially free of volatile solvents or carriers.
30. The method of any of embodiments 26 to 29, wherein the olefinic compound comprises a monomer.
31. The method of embodiment 30, wherein the olefinic compound comprises a (meth)acrylate, vinyl, vinyl ether, allyl ether, vinyl ester, unsaturated oil, unsaturated fatty acid, unsaturated polyester, unsaturated alkyd or combination thereof
32. The method of embodiment 30, wherein the olefinic compound comprises isobornyl(meth)acrylate, isodecyl(meth)acrylate, phenoxyethyl(meth)acrylate, trimethylolpropane tri(meth)acrylate, alkoxylated cyclohexane dimethanol di(meth)acrylate, trimethylolpropane ethoxylate tri(meth)acrylate, dipropylene glycol di(meth)acrylate, tripropylene glycol di(meth)acrylate, hexanediol di(meth)acrylate, tetrahydrofurfuryl(meth)acrylate, pentaerythritol tri(meth)acrylate, pentaerythritol tetra(meth)acrylate, di-pentaerythritol penta(meth)acrylate, di-(trimethylolpropane tetra(meth)acrylate), propoxylated glycerol tri(meth)acrylate, beta-carboxyethyl(meth)acrylate, bisphenol A ethoxylate di(meth)acrylate, ethoxylated neopentyl glycol di(meth)acrylate, propoxylated neopentyl glycol di(meth)acrylate, or combination thereof
33. The method of embodiment 30, wherein the olefinic compound comprises isobornyl(meth)acrylate, tripropylene glycol di(meth)acrylate, trimethylolpropane tri(meth)acrylate, bisphenol A ethoxylate di(meth)acrylate, trimethylolpropane ethoxylate tri(meth)acrylate, dipropylene glycol di(meth)acrylate, di-pentaerythritol penta(meth)acrylate, di-(trimethylolpropane tetra(meth)acrylate), propoxylated glycerol tri(meth)acrylate or combination thereof
34. The method of any of embodiments 26 to 33, wherein the olefinic compound comprises a mixture of an acrylate or methacrylate monomer and an unsaturated polyester, with the acrylate or methacrylate monomer representing a majority of the mixture.
35. The method of any of embodiments 26 to 29, wherein the olefinic compound comprises an oligomer.
36. The method of any of embodiments 26 to 29, wherein the olefinic compound comprises an unsaturated polyester or unsaturated alkyd.
37. The method of any of embodiments 26 to 36, wherein the non-olefinic resin comprises a finely-divided thermoplastic.
38. The method of any of embodiments 26 to 37, wherein the non-olefinic resin comprises a non-chlorinated resin.
39. The method of embodiment 38, wherein the non-olefinic resin comprises an acrylic polymer, cellulosic polymer, fluoropolymer, hydrocarbon resin, saturated polyester, saturated alkyd, silicone polymer, or a non-chlorinated, saturated vinyl polymer.
40. The method of embodiment 38, wherein the non-olefinic resin comprises polystyrene.
41. The method of any of embodiments 26 to 37, wherein the non-olefinic resin comprises a chlorinated resin.
42. The method of embodiment 41, wherein the non-olefinic resin comprises chlorinated polyvinyl chloride or a chlorinated polyolefin.
43. The method of any of embodiments 26 to 42, wherein a latex-containing primer or latex-containing topcoat is applied over the coating system.
44. The method of any of embodiments 26 to 43, wherein the cement fiberboard substrate is in the form of a siding product.
45. The method of any of embodiments 26 to 44, wherein the coated article when radiation cured can withstand at least 30 freeze-thaw cycles.
46. The method of any of embodiments 26 to 44, wherein the coated article can withstand at least 75 freeze-thaw cycles.
47. The method of any of embodiments 26 to 44, wherein the coated article can withstand at least 175 freeze-thaw cycles.
48. The method of any of embodiments 26 to 47, wherein the coating system has a VOC of less than about 5% based on the total weight of the coating system.
49. The method of any of embodiments 26 to 47, wherein the coating system has a VOC of less than about 2% based on the total weight of the coating system.

All patents, patent applications, and literature cited in the specification are hereby incorporated by reference in their entirety. In the case of any inconsistencies, the present disclosure, including any definitions therein will prevail. The invention has been described with reference to various specific and preferred embodiments and techniques. However, it should be understood that many variations and modifications may be made while remaining within the scope of the invention.

What is claimed is:

1. A coated article, comprising:
a cement fiberboard substrate; and
a radiation-curable nonaqueous coating system applied to the substrate, wherein the coating system comprises:
one or more olefinic compounds; and
one or more non-olefinic resins which are soluble or dispersible in the one or more olefinic compounds.

2. The article of claim 1, wherein the non-olefinic resin is dissolved or dispersed in the olefinic compound.

3. The article of any preceding claim, wherein the coating system further comprises an initiator system.

4. The article of claim 3, wherein the coating system comprises a UV photoinitiator.

5. The article of any preceding claim, wherein the coating system is substantially free of volatile solvents or carriers.

6. The article of any preceding claim, wherein the olefinic compound comprises a monomer.

7. The article of any preceding claim, wherein the olefinic compound comprises a (meth)acrylate, vinyl, vinyl ether, allyl ether, vinyl ester, unsaturated oil, unsaturated fatty acid, unsaturated polyester, unsaturated alkyd or combination thereof.

8. The article of any preceding claim, wherein the olefinic compound comprises isobornyl(meth)acrylate, isodecyl(meth)acrylate, phenoxyethyl(meth)acrylate, trimethylolpropane tri(meth)acrylate, alkoxylated cyclohexane dimethanol di(meth)acrylate, trimethylolpropane ethoxylate tri(meth)acrylate, dipropylene glycol di(meth)acrylate, tripropylene glycol di(meth)acrylate, hexanediol di(meth)acrylate, tetrahydrofurfuryl(meth)acrylate, pentaerythritol tri(meth)acrylate, pentaerythritol tetra(meth)acrylate, di-pentaerythritol penta(meth)acrylate, di-(trimethyolpropane tetra(meth)acrylate), propoxylated glycerol tri(meth)acrylate, beta-carboxyethyl(meth)acrylate, bisphenol A ethoxylate di(meth)acrylate, ethoxylated neopentyl glycol di(meth)acrylate, propoxylated neopentyl glycol di(meth)acrylate, di-(trimethyolpropane tetra(meth)acrylate) or combination thereof.

9. The article of any preceding claim, wherein the olefinic compound comprises isobornyl(meth)acrylate, tripropylene glycol di(meth)acrylate, trimethylolpropane tri(meth)acrylate, bisphenol A ethoxylate di(meth)acrylate, trimethylolpropane ethoxylate tri(meth)acrylate, dipropylene glycol di(meth)acrylate, di-pentaerythritol penta(meth)acrylate, di-(trimethyolpropane tetra(meth)acrylate), propoxylated glycerol tri(meth)acrylate or combination thereof.

10. The article of any preceding claim, wherein the olefinic compound comprises a mixture of an acrylate or methacrylate monomer and an unsaturated polyester, with the acrylate or methacrylate monomer representing a majority of the mixture.

11. The article of any of claims 1 to 5, wherein the olefinic compound comprises an oligomer.

12. The article of any of claims 1 to 5, wherein the olefinic compound comprises an unsaturated polyester or unsaturated alkyd.

13. The article of any preceding claim, wherein the non-olefinic compound comprises a finely-divided thermoplastic.

14. The article of any preceding claim, wherein the non-olefinic compound comprises a non-chlorinated resin.

15. The article of any preceding claim, wherein the non-olefinic compound comprises an acrylic polymer, cellulosic polymer, fluoropolymer, hydrocarbon resin, saturated polyester, saturated alkyd, silicone polymer, or a non-chlorinated, saturated vinyl polymer.

16. The article of any preceding claim, wherein the non-olefinic compound comprises polystyrene.

17. The article of any of claims 1 to 13, wherein the non-olefinic compound comprises a chlorinated resin.

18. The article of claim 17, wherein the non-olefinic compound comprises a polyvinyl chloride dispersion resin.

19. The article of claim 17, wherein the non-olefinic compound comprises chlorinated polyvinyl chloride or a chlorinated polyolefin.

20. The article of any preceding claim, wherein a latex-containing primer or latex-containing topcoat is applied over the coating system.

21. The article of any preceding claim, wherein the cement fiberboard substrate is in the form of a siding product.

22. The article of any preceding claim, wherein the coated article when radiation cured can withstand at least 30 freeze-thaw cycles.

23. The article of claim 22, wherein the coated article can withstand at least 75 freeze-thaw cycles.

24. The article of claim 22, wherein the coated article can withstand at least 175 freeze-thaw cycles.

25. The article of any preceding claim, wherein the coating system has a VOC of less than about 5% based on the total weight of the coating system.

26. The article of claim 25, wherein the coating system has a VOC of less than about 2% based on the total weight of the coating system.

27. A method for preparing a coated article, which method comprises providing a cement fiberboard substrate, coating at least a portion of the substrate with a nonaqueous coating system comprising one or more olefinic compounds and one or more non-olefinic resins dissolved or dispersed in the one or more olefinic compounds, and radiation-curing the coating.

28. The method of claim 27, wherein the coating system further comprises an initiator system.

29. The method of claim 28, wherein the coating system comprises a UV photoinitiator.

30. The method of any of claims 27 to 29, wherein the coating system is substantially free of volatile solvents or carriers.

31. The method of any of claims 27 to 30, wherein the olefinic compound comprises a monomer.

32. The method of claim 31, wherein the olefinic compound comprises a (meth)acrylate, vinyl, vinyl ether, allyl ether, vinyl ester, unsaturated oil, unsaturated fatty acid, unsaturated polyester, unsaturated alkyd or combination thereof.

33. The method of claim 31, wherein the olefinic compound comprises isobornyl(meth)acrylate, isodecyl(meth)acrylate, phenoxyethyl(meth)acrylate, trimethylolpropane tri(meth)acrylate, alkoxylated cyclohexane dimethanol di(meth)acrylate, trimethylolpropane ethoxylate tri(meth)acrylate, dipropylene glycol di(meth)acrylate, tripropylene glycol di(meth)acrylate, hexanediol di(meth)acrylate, tetrahydrofurfuryl(meth)acrylate, pentaerythritol tri(meth)acrylate, pentaerythritol tetra(meth)acrylate, di-pentaerythritol penta(meth)acrylate, di-(trimethyolpropane tetra(meth)acrylate), propoxylated glycerol tri(meth)acrylate, beta-carboxyethyl(meth)acrylate, bisphenol A ethoxylate di(meth)acrylate, ethoxylated neopentyl glycol di(meth)acrylate, propoxylated neopentyl glycol di(meth)acrylate, di-(trimethyolpropane tetra(meth)acrylate) or combination thereof.

34. The method of claim 31, wherein the olefinic compound comprises isobornyl(meth)acrylate, tripropylene glycol di(meth)acrylate, trimethylolpropane tri(meth)acrylate, bisphenol A ethoxylate di(meth)acrylate, trimethylolpropane ethoxylate tri(meth)acrylate, dipropylene glycol di(meth)acrylate, di-pentaerythritol penta(meth)acrylate, di-(trimethyolpropane tetra(meth)acrylate), propoxylated glycerol tri(meth)acrylate or combination thereof.

35. The method of any of claims 27 to 34, wherein the olefinic compound comprises a mixture of an acrylate or methacrylate monomer and an unsaturated polyester, with the acrylate or methacrylate monomer representing a majority of the mixture.

36. The method of any of claims 27 to 30, wherein the olefinic compound comprises an oligomer.

37. The method of any of claims 27 to 30, wherein the olefinic compound comprises an unsaturated polyester or unsaturated alkyd.

38. The method of any of claims 27 to 37, wherein the non-olefinic compound comprises a finely-divided thermoplastic.

39. The method of any of claims 27 to 38, wherein the non-olefinic compound comprises a non-chlorinated resin.

40. The method of claim 39, wherein the non-olefinic compound comprises an acrylic polymer, cellulosic polymer, fluoropolymer, hydrocarbon resin, saturated polyester, saturated alkyd, silicone polymer, or a non-chlorinated, saturated vinyl polymer.

41. The method of claim 39, wherein the non-olefinic compound comprises polystyrene.

42. The method of any of claims 27 to 38, wherein the non-olefinic compound comprises a chlorinated resin.

43. The method of claim 42, wherein the non-olefinic compound comprises a polyvinyl chloride dispersion resin.

44. The method of claim 42, wherein the non-olefinic compound comprises chlorinated polyvinyl chloride or a chlorinated polyolefin.

45. The method of any of claims 27 to 44, wherein a latex-containing primer or latex-containing topcoat is applied over the coating system.

46. The method of any of claims 27 to 45, wherein the cement fiberboard substrate is in the form of a siding product.

47. The method of any of claims 27 to 46, wherein the coated article when radiation cured can withstand at least 30 freeze-thaw cycles.

48. The method of any of claims 27 to 46, wherein the coated article can withstand at least 75 freeze-thaw cycles.

49. The method of any of claims 27 to 46, wherein the coated article can withstand at least 175 freeze-thaw cycles.

50. The method of any of claims 27 to 49, wherein the coating system has a VOC of less than about 5% based on the total weight of the coating system.

51. The method of any of claims 27 to 49, wherein the coating system has a VOC of less than about 2% based on the total weight of the coating system.
